(19) United States
(12) Patent Application Publication
(10) Pub. No.: US 2012/0155322 A1
(43) Pub. Date: Jun. 21, 2012

(54) Method And Apparatus For Network Node Discovery

(76) Inventors: Jaideep S. Lamba, Plano, TX (US); Chienwen Tien, Plano, TX (US); Liem Quang Le, Murphy, TX (US)

(21) Appl. No.: 12/971,092

(22) Filed: Dec. 17, 2010

(51) Int. Cl. H04L 12/28

(52) U.S. Cl. 370/254

(57) ABSTRACT

Various methods and devices are provided to address the need for improved network node discovery. In one method, a network node receives from a sending node a request indicating a criterion of interest to an originator node. If the network node meets the criterion, the network node sends a response to the originator node indicating that the network node meets the criterion. The network node also forwards the request to any nodes that neighbor the network node other than the sending node.

### FIELD OF THE INVENTION

The present invention relates generally to communications and, in particular, to node discovery in communication networks.

### BACKGROUND OF THE INVENTION

This section introduces aspects that may help facilitate a better understanding of the inventions. Accordingly, the statements of this section are to be read in this light and are not to be understood as admissions about what is prior art or what is not prior art.

In an autonomous dynamic ad-hoc/fixed network there is no central authority that maintains network topology and/or individual characteristics of member nodes. If an application on a node needs to find a set of nodes in the network that meet a certain criterion, there is no known, efficient way of discovering these nodes.

In current implementations, a central node will be selected to maintain all the said parameters and topology of the network and its associated hosts. Any node interested in a set of nodes meeting a set criterion would query this central node. The central node would then reply back to the originator node with a set of nodes. However, this approach has a number of potential issues:
(1) Central node is a single point of failure.
(2) There may be a significant amount of network traffic required to maintain this information and keep it current at the central node. This may prove to be quite wasteful, especially if the information stored on central node is used infrequently.
(3) The link to the central node may become a bottleneck in the network. This may be especially problematic in a wireless network with reduced link capacities if there are frequent queries of the central node.
(4) A centralized approach does not scale well in large networks with an increasing number of nodes and users.

A node interested in only a subset of nodes in the whole cluster (e.g., those separated by just two hops) won't be able to set that criterion when performing the search. In essence localized searches cannot be performed. Thus, new solutions and techniques that are able to address one or more of the issues encountered in current implementations would meet a need and advance wireless communications generally.

### BRIEF DESCRIPTION OF THE DRAWINGS

FIG. 1 is a block diagram depiction of network nodes in accordance with various embodiments of the present invention.

FIG. 2 is a logic flow diagram of functionality performed by a network node in accordance with various embodiments of the present invention.

FIG. 3 is a logic flow diagram of additional functionality performed by a network node in accordance with certain alternative embodiments of the present invention.

FIG. 4 is a logic flow diagram of additional functionality performed by a network node in accordance with certain alternative embodiments of the present invention.

FIG. 5 is a logic flow diagram of additional functionality performed by a network node in accordance with certain alternative embodiments of the present invention.

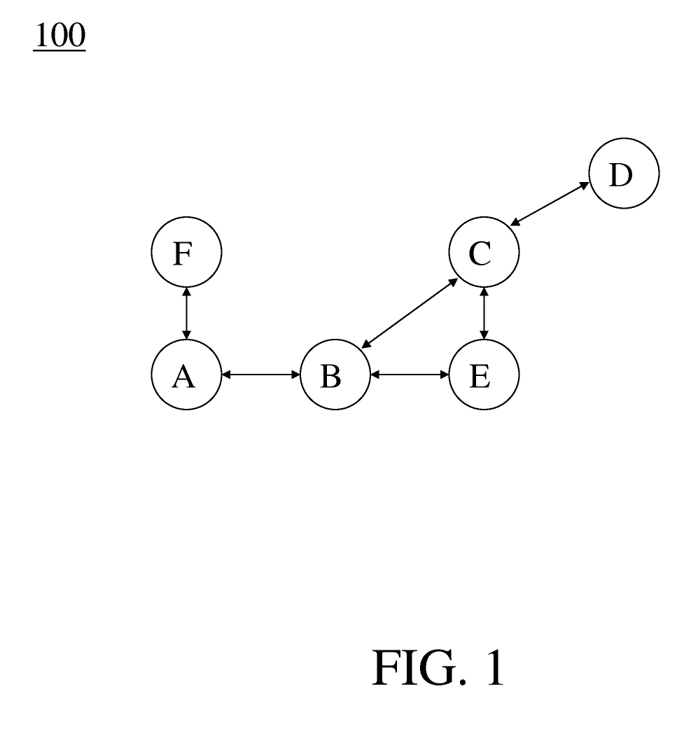

Specific embodiments of the present invention are disclosed below with reference to FIGS. 1-5. Both the description and the illustrations have been drafted with the intent to enhance understanding. For example, the dimensions of some of the figure elements may be exaggerated relative to other elements, and well-known elements that are beneficial or even necessary to a commercially successful implementation may not be depicted so that a less obstructed and a more clear presentation of embodiments may be achieved. In addition, although the logic flow diagrams above are described and shown with reference to specific steps performed in a specific order, some of these steps may be omitted or some of these steps may be combined, sub-divided, or reordered without departing from the scope of the claims. Thus, unless specifically indicated, the order and grouping of steps is not a limitation of other embodiments that may lie within the scope of the claims.

Simplicity and clarity in both illustration and description are sought to effectively enable a person of skill in the art to make, use, and best practice the present invention in view of what is already known in the art. One of skill in the art will appreciate that various modifications and changes may be made to the specific embodiments described below without departing from the spirit and scope of the present invention. Thus, the specification and drawings are to be regarded as illustrative and exemplary rather than restrictive or all-encompassing, and all such modifications to the specific embodiments described below are intended to be included within the scope of the present invention.

### SUMMARY OF THE INVENTION

Various methods and devices are provided to address the need for improved network node discovery. In one method, a network node receives from a sending node a request indicating a criterion of interest to an originator node. If the network node meets the criterion, the network node sends a response to the originator node indicating that the network node meets the criterion. The network node also forwards the request to any nodes that neighbor the network node other than the sending node. An article of manufacture is also provided, the article comprising a processor-readable storage medium storing one or more software programs which when executed by one or more processors performs the steps of this method.

Many embodiments are provided in which the method above is modified. For example, in many embodiments the forwarding of the request to any nodes that neighbor the network node involves forwarding the request to any nodes that are a single network hop from the network node. Also, in many embodiments, the network node decrements a hop count value included in the request prior to forwarding the request. Subsequent to forwarding the request, the network node may additionally handle various other events, depending on the embodiment. For example, the network node may detect a new neighboring node to which the request has not been forwarded and thus proceeds to forward the request to the new neighboring node. In another example, the network node may receive the request again but from a different sending node and determine that the request has already been forwarded to any nodes that neighbor the network node. In yet another example, the network node may receive a response for the originator node from a node to which the network node forwarded the request and then forward the received response towards the originator node.

In another method, an originator node sends to each network node, of a group of network nodes that neighbor the originator node, a request indicating a criterion of interest to the originator node. The originator node establishes a period of time during which to receive responses to the request sent to each network node of the group and collects information to identify which network nodes meet the criterion. An article of manufacture is also provided, the article comprising a processor-readable storage medium storing one or more software programs which when executed by one or more processors performs the steps of this method.

A network node apparatus is also provided. The network node being configured to communicate with other devices of a system and being operative to receive, from a sending node, a request indicating a criterion of interest to an originator node and to determine whether the network node meets the criterion. If the network node meets the criterion, the network node is operative to send a response to the originator node indicating that the network node meets the criterion. The network node is also operative to forward the request to any nodes that neighbor the network node other than the sending node.

### DETAILED DESCRIPTION OF EMBODIMENTS

To provide a greater degree of detail in making and using various aspects of the present invention, a description of our approach to the discovery of nodes that meet a given criterion and a description of certain, quite specific, embodiments follows for the sake of example. FIG. 1 is referenced in an attempt to illustrate some of these specific embodiments of the present invention.

We propose a distributed mechanism for discovering a set of nodes in a network. Consider an ad-hoc/fixed network with number of nodes. These nodes are connected to each other through one or more transport mediums. When a node is interested in a set of nodes meeting a certain criterion, it first discovers its neighbors by broadcasting its availability on the transport medium or through a routing protocol, like Ad hoc On-Demand Distance Vector (AODV) for ad hoc networks. Neighbors that are one hop away from this node would perform the following actions.
(1) If they meet the set criterion, they will reply back to the originator node with their parameters.
(2) Forward this request to their immediate neighbors.
(3) Add this request to their request list. This helps to maintain the information that this request has already been forwarded and address the suboptimal path situation. Hence, if the same request gets forwarded through some other suboptimal route to the same neighbor, it can avoid forwarding this information and thereby reduce the network traffic. Timer: This entry also has a timer associated with it. If a new neighbor is discovered before this entry expires this node will forward the request to the new neighbor. Sequence Number: If a new request comes from the same source node with the same id or sequence number, this node would update its entry with the new request and redo steps from 1.
(4) All the replies from its neighbors are forwarded back to the originator node.
   The originator node compiles all the responses and constructs a set of nodes meeting the set criterion.

Diagram 100 of FIG. 1 depicts network nodes A, B, C, D, E and F in accordance with various embodiments of the present invention. For the sake of illustration, nodes A, B, C, D, E and F are able to communicate with each other as depicted by the communication links depicted in diagram 100. Each of these communication links may take the form of wired communications, wireless communications or some combination of both. In some embodiments, nodes A, B, C, D, E and F may take the form of an ad hoc IEEE 802.11-based wireless local area network (WLAN) (a.k.a., a WiFi network), for example. To provide a detailed example, some embodiments involving nodes A, B, C, D, E and F may operate as follows:
1) A is a source node that wants to know all nodes in a network that meet a certain criterion.
2) A will forward such a request to F and B discovered through some well-known routing protocol. A will also start a timer T1 to wait for all the responses. A can also introduce a dissemination metric in its request like a hop count if it is interested in discovering only a portion of the nodes around it. This metric or hop counter will get decremented at all the intermediate nodes before they forward this request to other nodes.
3) F will
   Check the request and if it meets the criterion it will respond to A with the same identifier or sequence number as in the request.
   F will also insert this request into its list in case some other node comes into the vicinity of F. The timer associated with this entry is T2.
4) B will
   Check the request and if it meets the criterion it will respond to A with the same identifier or sequence number as in the request.
   B will forward the request to C and E.
   B will also insert this request into its list in case some other node comes into the vicinity of B. The timer associated with this entry is T2.
5) C will
   Check the request and if it meets the criterion it will respond to A with the same identifier or sequence number as in the request.
   C will forward the request to D.
   C will also insert this request into its list in case some other node comes into the vicinity of C. The timer associated with this entry is T2.
6) E will
   Check the request and if it meets the criterion it will respond to A with the same identifier or sequence number as in the request.
   E will forward the request to C. At this point C will disregard request from E as it is the same request that B has earlier forwarded. Hence, the unnecessary propagation of the request would be stopped here.
   E will also insert this request into its list in case some other node comes into the vicinity of E. The timer associated with this entry is T2.
7) D will
   Check the request and if it meets the criterion it will respond to A with the same identifier or sequence number as in the request.
   D will also insert this request into its list in case some other node comes into the vicinity of D. The timer associated with this entry is T2.
(1) At timer T1 expiry, A can either
   Restart the cycle. If nodes like B, C, D, E and F get a second request from node A identified by the same identifier or sequence number then they would update all the associated request entries from A and restart the entry associated timers.
   Initiate a new request. If nodes like B, C, D, E and F get a new request from node A identified by a different identifier or sequence number then they would create new entries as explained earlier.
   Just compile a list of the nodes that responded and utilize the information in accordance with the activities that triggered the node discovery cycle. If no nodes reply then node A can increase the dissemination metric and/or increase the T1 timers and restart the cycle. Node A can retry for a configurable number of tries to avoid flooding the network with unnecessary requests.
(2) At timer T2 expiry the corresponding entries from node A present in the node B, C, D, E and F lists are all deleted.

Thus, the embodiments described above provide an example of how a set of nodes that meet a certain criterion can be discovered. Network traffic to discover these nodes is triggered when a node requests that information. The set of nodes discovered is current with respect to topology, and topology changes, like the addition of nodes, can be handled automatically without triggering a second request. Also, the network traffic required to discover this information can be controlled by the use of timers, forward flags and/or path metrics. In sum, a solution is provided to network discovery that is distributed, that is not vulnerable to a single point failure, and that reduces the need to maintain complete network information such as topology, parameters, etc.

The detailed and, at times, very specific description above is provided to effectively enable a person of skill in the art to make, use, and best practice the present invention in view of what is already known in the art. In the examples, specifics are provided for the purpose of illustrating possible embodiments of the present invention and should not be interpreted as restricting or limiting the scope of the broader inventive concepts.

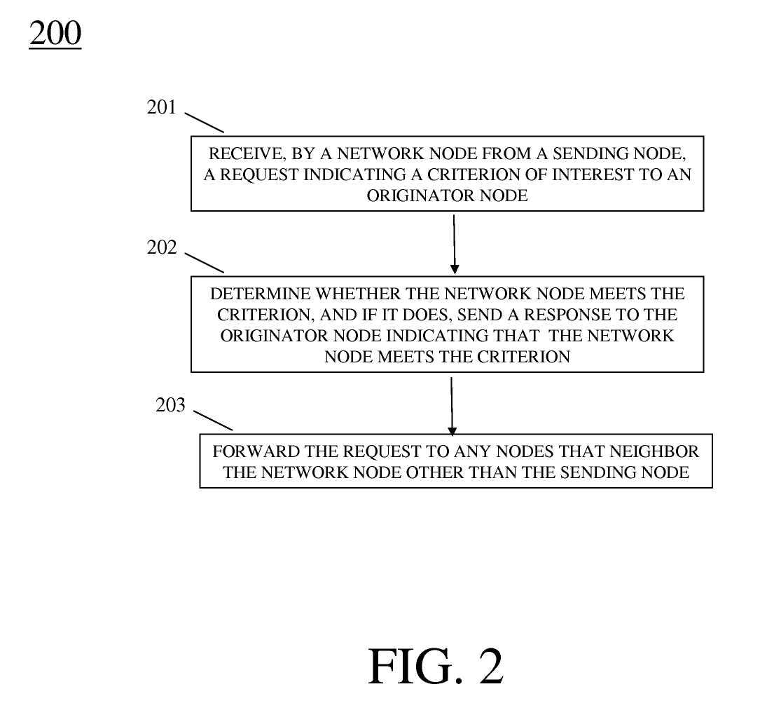

Aspects of embodiments of the present invention can be further understood with reference to FIGS. 2-5. FIG. 2 is a logic flow diagram of functionality performed by a network node in accordance with various embodiments of the present invention. Logic flow 200 begins when a network node receives (201) from a sending node a request indicating a criterion of interest to an originator node. If the network node meets the criterion, the network node sends (202) a response to the originator node indicating that the network node meets the criterion. The network node also forwards (203) the request to any nodes that neighbor the network node other than the sending node.

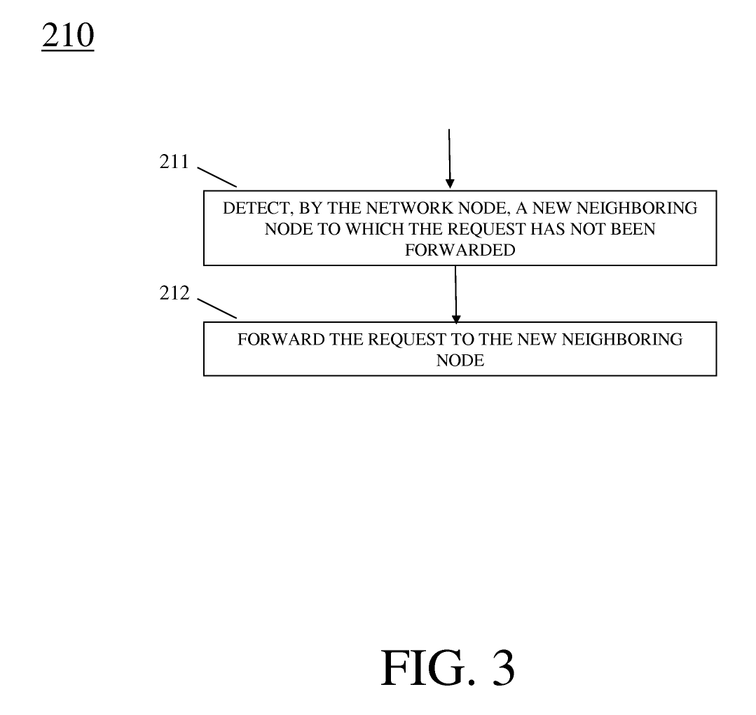

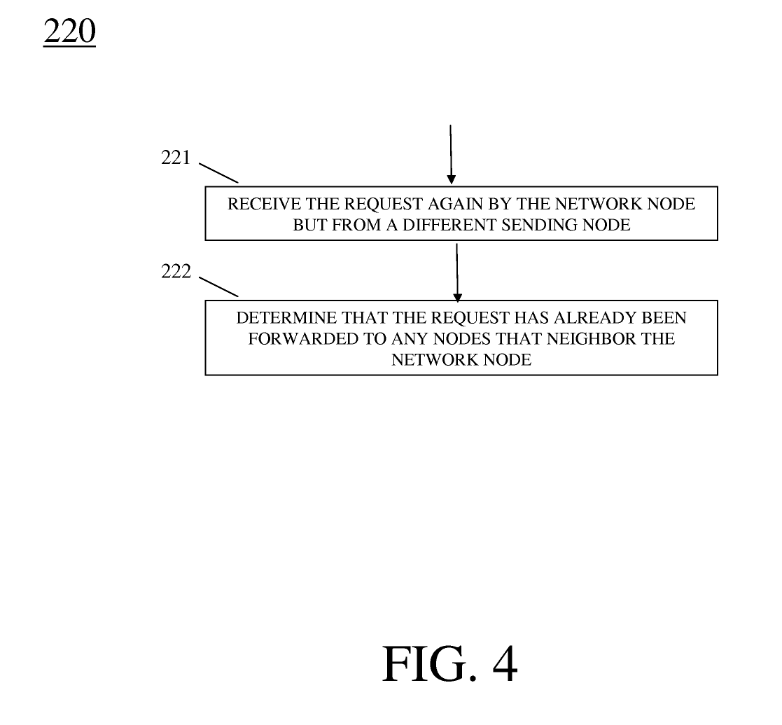

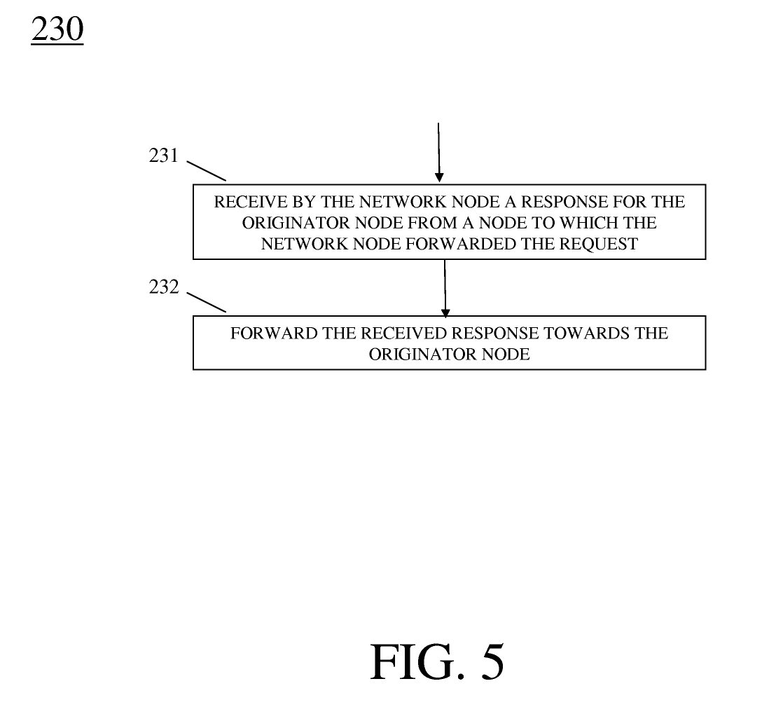

Many embodiments are provided herein in which the method and logic flow above may be modified. Subsequent to forwarding (203) the request, the network node may additionally handle various other events, depending on the embodiment. Logic flow diagrams 210, 220 and 230 in FIGS. 3-5 depict some of these alternative embodiments. For example, in FIG. 3, the network node may detect (211) a new neighboring node to which the request has not been forwarded and thus proceeds to forward (212) the request to the new neighboring node. In another example, which is depicted in FIG. 4, the network node may receive (221) the request again but from a different sending node and determine (222) that the request has already been forwarded to any nodes that neighbor the network node. In yet another example, which is depicted in FIG. 5, the network node may receive (231) a response for the originator node from a node to which the network node forwarded the request. It then forwards (232) the received response towards the originator node.

Benefits, other advantages, and solutions to problems have been described above with regard to specific embodiments of the present invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

As used herein and in the appended claims, the term “comprises,” “comprising,” or any other variation thereof is intended to refer to a non-exclusive inclusion, such that a process, method, article of manufacture, or apparatus that comprises a list of elements does not include only those elements in the list, but may include other elements not expressly listed or inherent to such process, method, article of manufacture, or apparatus. The terms a or an, as used herein, are defined as one or more than one. The term plurality, as used herein, is defined as two or more than two. The term another, as used herein, is defined as at least a second or more. Unless otherwise indicated herein, the use of relational terms, if any, such as first and second, top and bottom, and the like are used solely to distinguish one entity or action from another entity or action without necessarily requiring or implying any actual such relationship or order between such entities or actions.

The terms including and/or having, as used herein, are defined as comprising (i.e., open language). The term coupled, as used herein, is defined as connected, although not necessarily directly, and not necessarily mechanically. Terminology derived from the word “indicating” (e.g., “indicates” and “indication”) is intended to encompass all the various techniques available for communicating or referencing the object/information being indicated. Some, but not all, examples of techniques available for communicating or referencing the object/information being indicated include the conveyance of the object/information being indicated, the conveyance of an identifier of the object/information being indicated, the conveyance of information used to generate the object/information being indicated, the conveyance of some part or portion of the object/information being indicated, the conveyance of some derivation of the object/information being indicated, and the conveyance of some symbol representing the object/information being indicated.

What is claimed is:

1. A method for node discovery, the method comprising:
receiving, by a network node from a sending node, a request indicating a criterion of interest to an originator node;
determining whether the network node meets the criterion;
if the network node meets the criterion, sending a response to the originator node indicating that the network node meets the criterion;
forwarding the request to any nodes that neighbor the network node other than the sending node.

2. The method as recited in claim 1, further comprising
detecting, by the network node, a new neighboring node to which the request has not been forwarded;
forwarding the request to the new neighboring node.

3. The method as recited in claim 1, further comprising
receiving the request again by the network node but from a different sending node;
determining that the request has already been forwarded to any nodes that neighbor the network node.

4. The method as recited in claim 1, further comprising
receiving by the network node a response for the originator node from a node to which the network node forwarded the request;
forwarding the received response towards the originator node.

5. The method as recited in claim 1, wherein forwarding the request to any nodes that neighbor the network node comprises
forwarding the request to any nodes that are a single network hop from the network node.

6. The method as recited in claim 1, further comprising
decrementing a hop count value included in the request prior to forwarding the request to any nodes that neighbor the network node.

7. An article of manufacture comprising a processor-readable storage medium storing one or more software programs which when executed by one or more processors performs the steps of the method of claim 1.

8. A method for node discovery, the method comprising:
sending, by an originator node to each network node of a group of network nodes that neighbor the originator node, a request indicating a criterion of interest to the originator node;
establishing a period of time during which to receive responses to the request sent to each network node of the group;
collecting information to identify which network nodes meet the criterion.

9. The method as recited in claim 8, further comprising
including in the request a dissemination metric to limit the extent of node discovery.

10. The method as recited in claim 9, wherein the dissemination metric comprises a hop count value.

11. An article of manufacture comprising a processor-readable storage medium storing one or more software programs which when executed by one or more processors performs the steps of the method of claim 8.

12. A network node of a communication system, the network node being configured to communicate with other devices in the system, wherein the network node is operative
to receive, from a sending node, a request indicating a criterion of interest to an originator node,
to determine whether the network node meets the criterion,
to send, if the network node meets the criterion, a response to the originator node indicating that the network node meets the criterion and
to forward the request to any nodes that neighbor the network node other than the sending node.

13. The network node as recited in claim 12, wherein the network node is further operative
to detect a new neighboring node to which the request has not been forwarded and
to forward the request to the new neighboring node.

14. The network node as recited in claim 12, wherein the network node is further operative
to receive the request again but from a different sending node and
to determine that the request has already been forwarded to any nodes that neighbor the network node.

15. The network node as recited in claim 12, wherein the network node is further operative
to receive a response for the originator node from a node to which the network node forwarded the request and
to forward the received response towards the originator node.

16. The network node as recited in claim 12, wherein being operative to forward the request to any nodes that neighbor the network node comprises being operative
to forward the request to any nodes that are a single network hop from the network node.

17. The network node as recited in claim 12, wherein the network node is further operative
to decrement a hop count value included in the request prior to forwarding the request to any nodes that neighbor the network node.
